(19) United States
(12) Patent Application Publication
(10) Pub. No.: US 2002/0065761 A1
(43) Pub. Date: May 30, 2002

(54) Subscriber notification criteria for electronic auctions

(76) Inventors: David Howard Fischer, Georgetown, TX (US); Rebecca Lynn Roberts, Austin, TX (US); Susan Schlichter Ruyle, Austin, TX (US); Leland James Wiesehuegel, Austin, TX (US)

Correspondence Address: Duke W. Yee, Carstens, Yee & Cahoon, LLP, P. O. Box 802334, Dallas, TX, 75380, US

(21) Appl. No.: 09/726,010

(22) Filed: Nov. 29, 2000

(51) Int. Cl. G06F 17/60

(52) U.S. Cl. 705/37

(57) ABSTRACT

A method and system for notifying a client of a status of an electronic auction is provided. A notification preference is received, the notification preference identifies when to notify the client of a status of the electronic auction. The notification preference is matched to a current status of the electronic auction. Then the notification to the client is transmitted based on the matching of the notification preference to the current status of the electronic auction.

### BACKGROUND OF THE INVENTION

1. Technical Field

The present invention relates generally to an improved data processing system and in particular to notification parameters to be used within the data processing system environment. Still more particularly, the present invention provides notification criteria used for electronic auctions.

2. Description of the Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and Secretaries of State. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML).

In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and businesses use the Web to purchase various goods and services. In offering goods and services, some companies offer goods and services solely on the Web while others use the Web to extend their reach. Software vendors are also part of the expanded use of the Internet. Valuable information may be obtained by simply accessing a software vendor's web page.

On-line auction houses are a popular and growing segment of available services from the Internet. With the appearance of auction websites, such as Ebay.com and Amazon.com, the popularity of on-line auction houses is almost certain to grow at an expanding pace. Both the buyer and the seller subscribe to the on-line auction house. The concept of on-line auction houses is very similar to the traditional form of auctioning of goods and services. For instance, a seller offers an item for sale, sets a minimum bid, and bidders may bid on the product with the winning bidder being able to buy the product at the winning bid price.

The difference between on-line auction houses and traditional auctioning is that both the seller and the bidder may participate in the auction without the need to travel to the site where the auction is being held. This alleviates the need for both the bidder and the seller to travel through inclimate weather, over long distances and to unknown locations to attend the auction. Both the bidder and the seller may complete the entire auction from his or her computer. Another improvement over the traditional auction process is that a bidder may bid any time of the day or night while the item is up for auction.

At present, many current on-line auction houses notify a subscriber of the status of a bid during and after an interactive auction of a particular good or service. A subscriber may be an interested participant in an Internet auction which includes both a buyer and a seller. For example, during the time an item is offered, buyers are notified when their bids are entered, when their bids are exceeded, and when they submit the highest bids. Also, if the auction has multiple winners, i.e. a dutch auction, the bidders are notified when their bids are exceeded and when their bid is below the lowest high bid for the available lots. In addition, some on-line auction houses send out batch notices every night with a status update for each current item offered for sale for which the subscriber has bid. These batch notices include all auctions the subscriber is involved in, whether or not the auctions are expiring that day and whether or not the subscriber has the high bid. This makes it very difficult for a subscriber to monitor specific items, and does not allow a subscriber to specify what the status of the bid should be before being notified.

A second mechanism provided by some on-line auction houses is to provide a web-page for the subscriber to monitor all the subscriber's outstanding auctions, but again, tracking specific items remains difficult. This also requires the subscriber to access the particular auction house website. A third mechanism is to notify the subscriber by electronic mail immediately whenever one of the subscriber's bids has been exceeded. However, for subscribers buying or selling multiple items, this procedure fills up the subscriber's electronic mail account, and as in the first two notification schemes, this does not allow the subscriber to specify what the status of the bid should be before being notified.

Therefore, it would be advantageous to have an improved method for buyer and seller notification criteria for electronic auctions.

### SUMMARY OF THE INVENTION

The present invention provides a method and system for notifying a client of a status of an electronic auction. A notification preference is received, the notification preference identifies when to notify the client of a status of the electronic auction. The notification preference is matched to a current status of the electronic auction. Then the notification to the client is transmitted based on the matching of the notification preference to the current status of the electronic auction.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary pictorial representation of a distributed data processing system in which the present invention may be implemented;

FIG. 2 is an exemplary block diagram illustrating a data processing system that may be implemented as a server in which the present invention may be implemented;

FIG. 3 is an exemplary block diagram illustrating a data processing system that may be implemented as a client in which the present invention may be implemented;

FIG. 4 is an exemplary illustration of an electronic auction buyer notification preferences screen in accordance with a preferred embodiment of the present invention;

FIG. 5 is an exemplary illustration of electronic auction seller notification preferences screen in accordance with a preferred embodiment of the present invention;

FIG. 6 is an exemplary illustration of electronic auction buyer item notification preferences screen in accordance with a preferred embodiment of the present invention;

FIG. 7 is an exemplary illustration of electronic auction seller item notification preferences screen in accordance with a preferred embodiment of the present invention;

FIG. 8 is an exemplary flowchart illustrating the general process of establishing electronic auction notification preferences for a buyer and seller in accordance with a preferred embodiment of the present invention;

FIG. 9 is an exemplary flowchart illustrating the process of establishing electronic auction buyer item notification preferences in accordance with a preferred embodiment of the present invention;

FIG. 10 is an exemplary flowchart illustrating the process of establishing electronic auction seller item notification preferences in accordance with a preferred embodiment of the present invention;

FIG. 11 is an exemplary flowchart illustrating the process of notifying an electronic auction participant in accordance with a preferred embodiment of the present invention; and

FIG. 12 is an exemplary flowchart illustrating the process of notifying an electronic auction participant of the status of an auctioned item in accordance with a preferred embodiment of the present invention.

### DETAILED DESCRIPTION OF THE PREFERRED EMBODIMENT

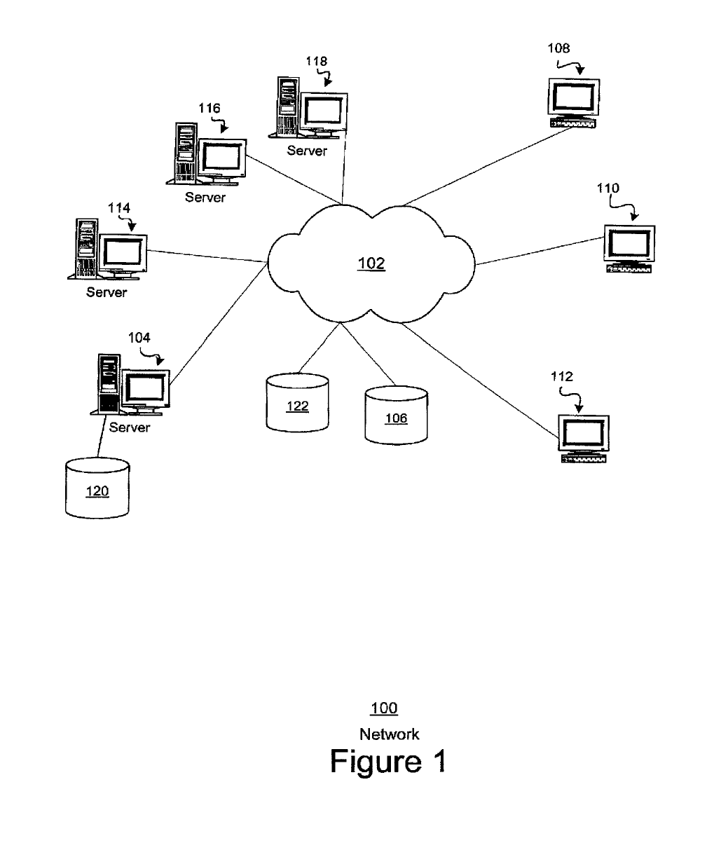

With reference now to the figures, and in particular with reference to FIG. 1, a pictorial representation of a distributed data processing system is depicted in which the present invention may be implemented.

Distributed data processing system 100 is a network of computers. Distributed data processing system 100 contains network 102, which is the medium used to provide communications links between various devices and computers connected within distributed data processing system 100. Network 102 may include permanent connections, such as wire or fiber optic cables, or temporary connections made through telephone connections. In addition, network 102 may include wireless connections, such as, for example, personal digital assistants (PDAs), palm pilots, cellular telephone, and the like.

In the depicted example, servers 104, 114, 116 and 118 are connected to network 102. Storage units 106 and 122 are also connected to network 102, providing backup support for any or all of servers 104, 114, 116 and 118. Storage unit 120 provides dedicated backup support for server 104. In addition, clients 108, 110 and 112 are also connected to network 102. These three clients may be, for example, personal computers or network computers. For purposes of this application, a network computer is any computer coupled to a network, which receives a program or other application from another computer coupled to the network. Distributed data processing system 100 may include additional servers, clients, and other devices not shown.

In the depicted example, servers 104, 114, 116 and 118 provide storage for data from clients 108, 110 and 112. These four servers also provide data, such as boot files, operating system images, and applications to clients 108, 110 and 112. Clients 108, 110 and 112 are clients to one or all of servers 104, 114, 116 and 118. Support for a particular application being performed on one of clients 108, 110 and 112 may be by one of servers 104, 114, 116 and 118. Additionally servers 104, 114, 116 and 118 may provide backup support for each other. In the event of a server failure, a redundant backup server may be allocated by the network administrator, in which case requests directed to the failed server are routed to the redundant backup server.

In the depicted example, distributed data processing system 100 may be the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 may also be implemented as a number of different types of networks, such as, for example, an intranet, extranet, or a local area network.

FIG. 1 is intended as an example and not as an architectural limitation for the processes of the present invention. For example, network 102 may use other hardware devices, such as, plotters, optical scanners, and the like in addition or in place of the hardware depicted in FIG. 1.

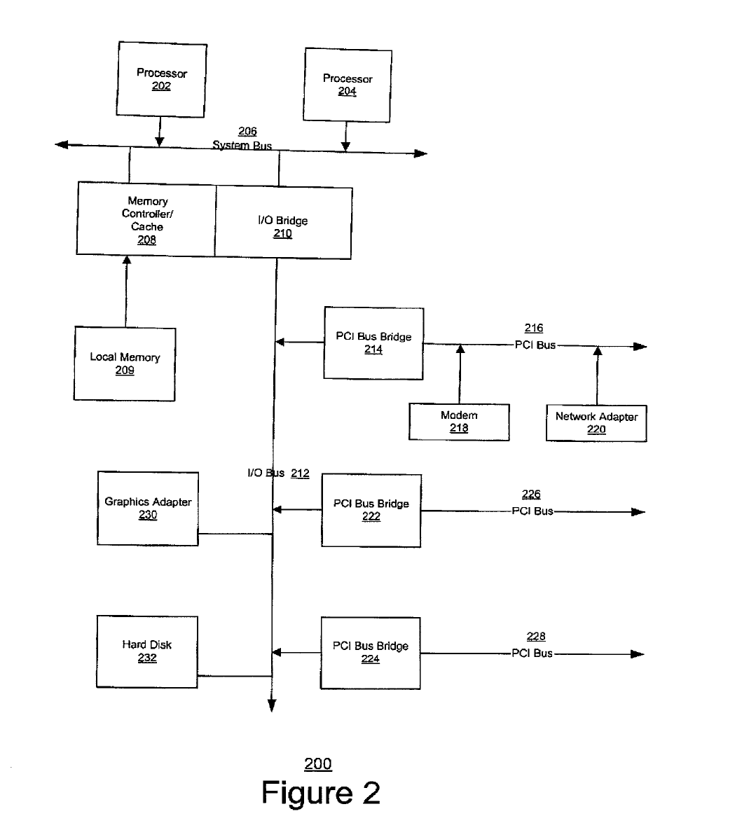

FIG. 2 is a block diagram illustrating a data processing system that may be implemented as a server in which the present invention may be implemented. The server in FIG. 2 may be server 104 in FIG. 1. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. Any number of modems, such as, for example, modem 218, may be connected to PCI bus 216. Typical PCI bus implementations will support four PCI expansion slots or add-in connectors. Communication links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000, a product of International Business Machines Corporation in Armonk, N.Y., running the Advanced Interactive Executive (AIX) operating system. Other supported operating systems may be Solaris from Sun Microsystems and Windows NT from Microsoft.

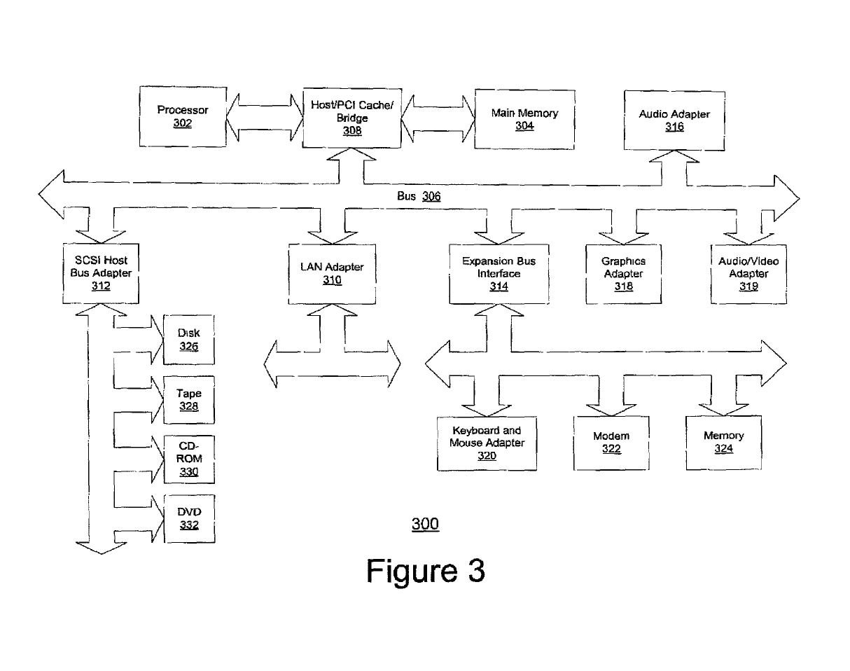

FIG. 3 is a block diagram illustrating a data processing system that may be implemented as a client in which the present invention may be implemented. Data processing system 300 is an example of a client computer, such as, for example, client computers 108, 110, and 112 in FIG. 1. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention.

The present invention provides subscriber notification criteria for electronic auctions. A subscriber may be an interested participant in an electronic auction which includes both a buyer and a seller. A subscriber may have a profile which is established when subscribing to or joining the electronic auction facility. A subscriber profile may contain the subscriber's name, mailing address, e-mail address, and the like. A subscriber may participate actively in the auction or monitor the auction. A subscriber establishes notification criteria on the status of the bidding sequence which include both bids placed by a buyer and seller's items placed for bid. The subscriber may choose to indicate when and by what method, to be notified during the bidding period when the status of an item has changed. The subscriber may choose a variety of periods, during the bidding period, to be notified and may choose a variety of methods in which the notification is transmitted. The bid or item notification criteria of the present invention keeps the subscriber well informed as to the current status of the buyer's bid or seller's auction item as well as any changes in the status of the buyer's bid or seller's auction item. Other features may be included in the present invention. For example, notification options for subscribers who want to monitor an item may include notification of the closing of the bid period, within a subscriber specified time period, for those subscribers who may not want to commit to bidding on a item while another similar item's bidding period is currently open. A subscriber may be notified when an item's reserve price has been met, and the preferences may include issuance of the summary report when an auction for a specific item closes, or perhaps at the halfway point of the auction for a specific item. In addition, a summary report may be issued and sent to a subscriber by regular postal mail.

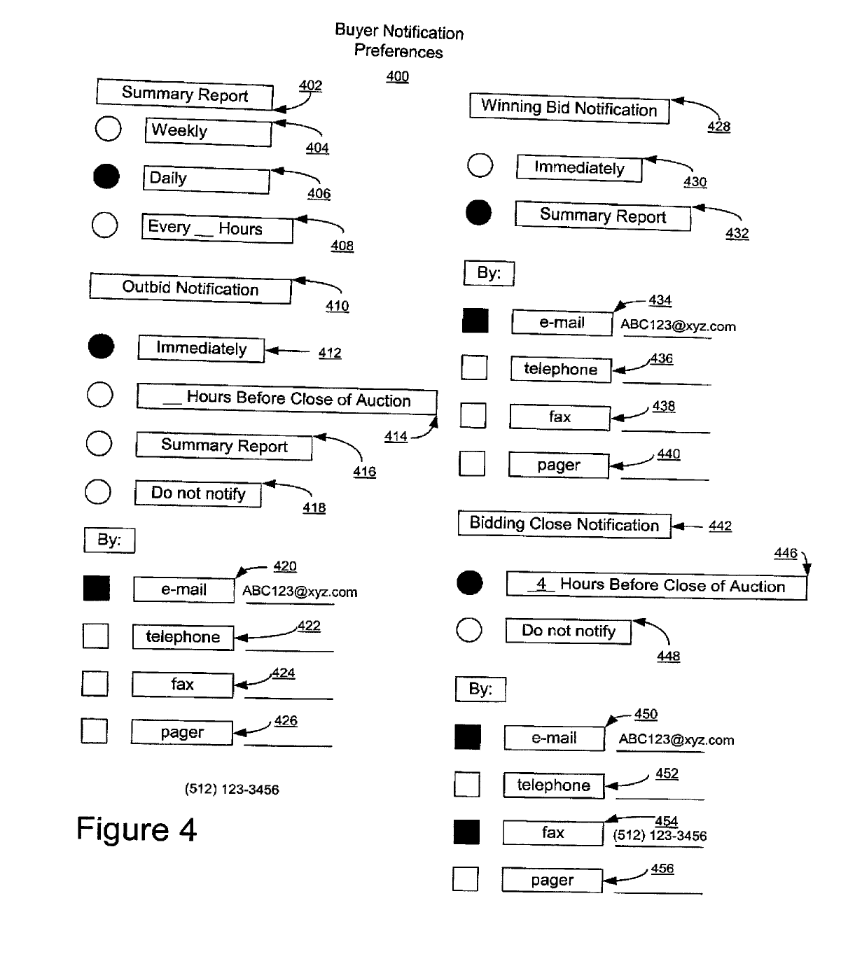

FIG. 4 is an exemplary illustration of an electronic auction buyer notification preferences screen in accordance with a preferred embodiment of the present invention. The buyer notification screen may be accessed by way of an applet from a server, a web page, an application running on a client, and the like. The present invention allows the buyer in an electronic auction to stay informed on the status of all bid items for which the buyer has placed a bid. The buyer may specify custom parameters for notification or allow notification to be according to default parameters. Notification preferences of the status of the buyer's current bid items may be varied. In addition, a buyer may be an active participant in the auction or may be monitoring the auction without placing a current bid. Thus, the present invention allows notification to subscribers in an electronic auction with varying degrees of interest in the auction.

The summary report, which lists all current bid items for which the buyer has chosen to be notified, may be designated to be sent to the buyer on a periodic basis, that is, more or less frequent than the default schedule. Also, outbid notifications or bid increase notifications may be designated to be sent to the buyer on a periodic basis, that is, more or less frequent than the default schedule. In addition, outbid or bid increase notifications may be designated to be sent to the buyer by means other than the default method, e.g., electronic mail. Furthermore, a bid's status may be extended to the designation of notification of a winning bid and the close of bidding on auctioned items. As with an outbid notification, winning bid notification and notification of the closing of an item's bidding period may be communicated to the buyer by means other than the default method.

In this example, buyer notification preferences screen 400 includes a summary report 402 which contains weekly 404, daily 406 and periodic hourly 408 notification selections. A summary report may include items the subscriber is high bidder on, the high bid amount, the date and time the auctions ends on specific items, and the like. The subscriber/buyer may choose any one of these options that will take precedence over the default delivery of the summary report. In this example, the subscriber/buyer has chosen a summary report 402 to be delivered to the subscriber/buyer daily 406. In addition, buyer notification screen 400 includes outbid notification 410, winning bid notification 428 and bidding close notification 442. A subscriber/buyer may designate when to be alerted if any of these situations occur during the course of bidding on an item. In addition, the subscriber/buyer may choose the method by which to be alerted or a condition using selections 420-426, 434-440 and 450-456.

A subscriber may be high bidder on an item and subsequently be outbid by another subscriber. An outbid is when one subscriber is willing to pay more for an item than the current bid amount. Notification of an outbid may be given to a subscriber. For example, subscriber/buyer outbid notification 410 contains the choice of the subscriber/buyer being notified immediately 412, before a subscriber/buyer defined number of hours before the close of the auction 414, to be alerted in the summary report 416 or to not be notified 418. The subscriber/buyer may choose to be alerted of an outbid by e-mail 420, telephone 422, fax 424, or pager 426. Furthermore, e-mail 420, telephone 422, fax 424, and pager 426 has a corresponding field in which the subscriber/buyer may place the appropriate address in the case of e-mail 420, or dialing digits, in the case of telephone 422, fax 424 and pager 426. The subscriber/buyer may choose one or more of these notification methods. In this example, the subscriber/buyer has chosen outbid notification 410 to be delivered immediately 412 by e-mail 420 with the subscriber/buyer's e-mail address, ABC123@xyz.com, placed in e-mail's 420 corresponding field.

A subscriber may be a winning bidder on an item. A winning bid is when a subscriber continues to have the high bid until the end of the auction period for the item. Therefore, the subscriber/buyer may also designate winning bid notification 428 which may be immediately 430 or in the periodic summary report 432. Winning bid notification 428 may be made by options such as e-mail 434, telephone 436, fax 438 and/or pager 440 with the appropriate address placed in the corresponding field, in the case of e-mail 434 and dialing digits placed in the corresponding fields for telephone 436, fax 438 and pager 440. As in outbid notification 410, the subscriber/buyer may choose one or more of these notification methods. In this example, the subscriber/buyer has chosen winning bid notification 428 to be delivered to the subscriber/buyer by e-mail 434 with the subscriber/buyer's e-mail address, ABC123@xyz.com, placed in e-mail's 434 corresponding field.

Eventually, each auction item has a bid closing. A bid closing is when the period designated for bidding elapses. Therefore, the subscriber/buyer may also designate bidding close notification 442 that may be a subscriber/buyer defined number of hours before close of the auction 446 or may choose to not be notified of the bid closing 448. Bidding close notification 442 may be made by e-mail 450, telephone 452, fax 454 and/or pager 456 with the appropriate address or dialed digits being placed in the corresponding field. As in outbid notification 410 and winning bid notification 428, the subscriber/buyer may choose one or more of these notification methods. In this example, the subscriber/buyer has designated bidding close notification 442 to be delivered 4 hours before close of the auction 446 by both e-mail 450 and fax 454 with the corresponding e-mail address, ABC123@xyz.com, placed in e-mail's 450 corresponding field and the corresponding dialing digits, (512) 123-3456, placed in fax's 454 corresponding field.

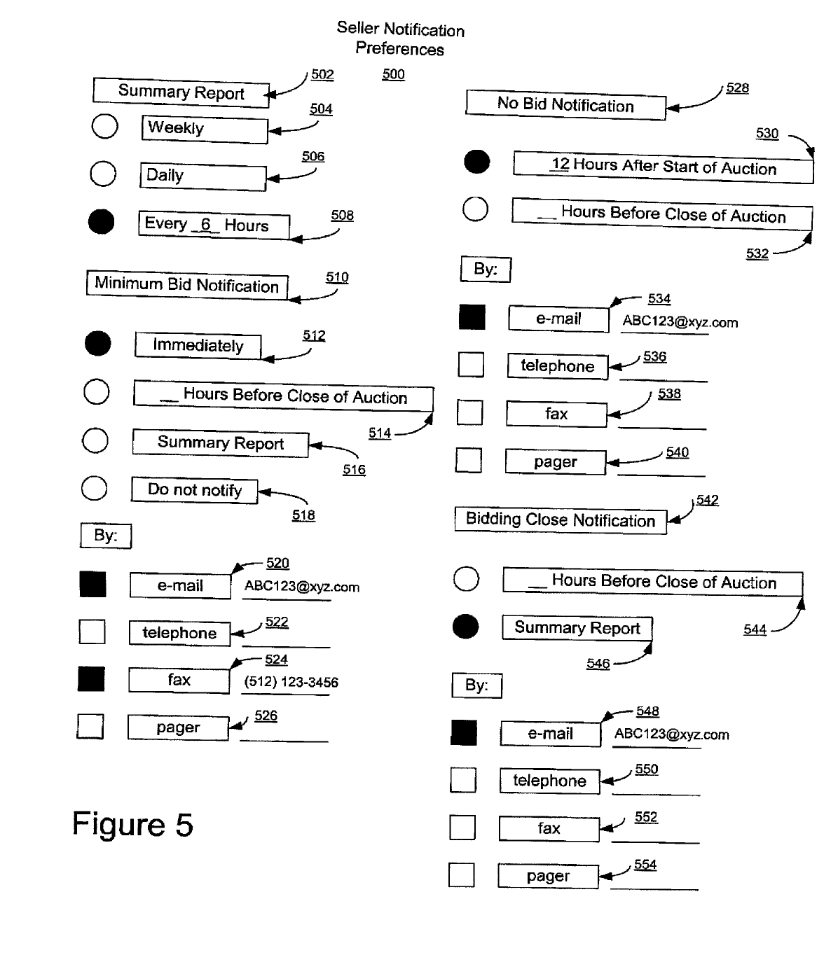

FIG. 5 is an exemplary illustration of electronic auction seller notification preferences screen in accordance with a preferred embodiment of the present invention. The seller notification preference screen may be similar to the previously described buyer notification preference screen. The present invention allows the seller in an electronic auction to stay informed on the status of all bid items for which the seller has placed in the auction. The seller may specify custom parameters for notification on a particular item or allow notification to be according to default parameters. Notification preferences of the status of the seller's current offered auction items may be varied.

The summary report, which lists all current items the seller has placed in auction, may be designated to be sent to the seller on a periodic basis that is more or less frequent than the default schedule. Also, minimum bid notifications may be designated to be sent to the seller on a periodic basis that is more or less frequent than the default schedule and, in addition, may be designated to be sent to the buyer by means other than the default electronic mail. Furthermore, an offered item's status may be extended to the designation of notification of a no bid situation and the close of bidding on the offered items. As with a minimum bid notification, no bid notification and notification of the closing of an item's bidding period may be communicated to the buyer by means other than electronic mail.

In this example, seller notification preferences screen 500 includes a summary report 502 which contains weekly 504, daily 506 and periodic hourly 508 notification selections. The subscriber/seller may choose any one of these options which will take precedence over a default delivery of the summary report. In this example, the subscriber/seller has chosen a summary report 502 to be delivered to the subscriber/seller on a subscriber/seller defined every 6 hours 508. In addition, buyer notification screen 500 includes minimum bid notification 510, no bid notification 528 and bidding close notification 542. A subscriber/seller may designate when to be alerted if any of these situations occur during the course of offering an item for auction. In addition, the subscriber/seller may choose the method by which to be alerted in a manner similar to that described above with regard to FIG. 4.

For example, subscriber/seller minimum bid notification 510 contains the choice of the subscriber/seller being notified immediately 512, before a subscriber/seller defined number of hours before the close of the auction 514, to be alerted in the summary report 516 or do not notify 518. The subscriber/seller may choose to be alerted of the placing of the minimum bid amount by e-mail 520, telephone 522, fax 524, or pager 526. Furthermore, e-mail 520, telephone 522, fax 524, and pager 526 has a corresponding field in which the subscriber/seller may place the appropriate address or dialing digits. The subscriber/seller may choose one or more of these notification methods. In this example, the subscriber/seller has chosen minimum bid notification 510 to be delivered immediately 512 by e-mail 520 with the subscriber/seller's e-mail address, ABC123 @xyz.com, placed in e-mail's 520 corresponding field and by fax 524 with the subscriber/seller's fax number, (512) 123-3456, placed on fax's 524 corresponding field.

The subscriber/seller may also designate no bid notification 528 which may be a subscriber/seller defined number of hours after start of the auction 530 or a subscriber/seller defined number of hours before close of the auction 532. A no bid is when a period of time has elapsed from the start of the auction and no bids have been received on an item. No bid notification 528 may be made by e-mail 534, telephone 536, fax 538 and/or pager 540 with the appropriate address placed in the corresponding field in the case of e-mail 534 and dialing digits placed in the corresponding fields for telephone 536, fax 538 and pager 540. As in minimum bid notification 510, the subscriber/seller may choose one or more of these notification methods. In this example, the subscriber/seller has chosen no bid notification 528 12 hours after the start of the auction 530 and to be delivered to the subscriber/seller by e-mail 534 with the subscriber/seller's e-mail address, ABC123@xyz.com, placed in e-mail's 534 corresponding field.

The subscriber/buyer may also designate bidding close notification 542 which may be a subscriber/buyer defined number of hours before close of the auction 544 or may choose to be alerted in summary report 546. Bidding close notification 542 may be made by e-mail 548, telephone 550, fax 552 and/or pager 556 with the appropriate address placed in the corresponding field in the case of e-mail 548 and dialing digits placed in the corresponding fields for telephone 550, fax 552 and pager 554. As in minimum bid notification 510 and no bid notification 528, the subscriber/seller may choose one or more of these notification methods. In this example, the subscriber/seller has designated bidding close notification 542 to be delivered in summary report 546 by e-mail 548 with the corresponding e-mail address, ABC123@xyz.com, placed in e-mail's 548 corresponding field.

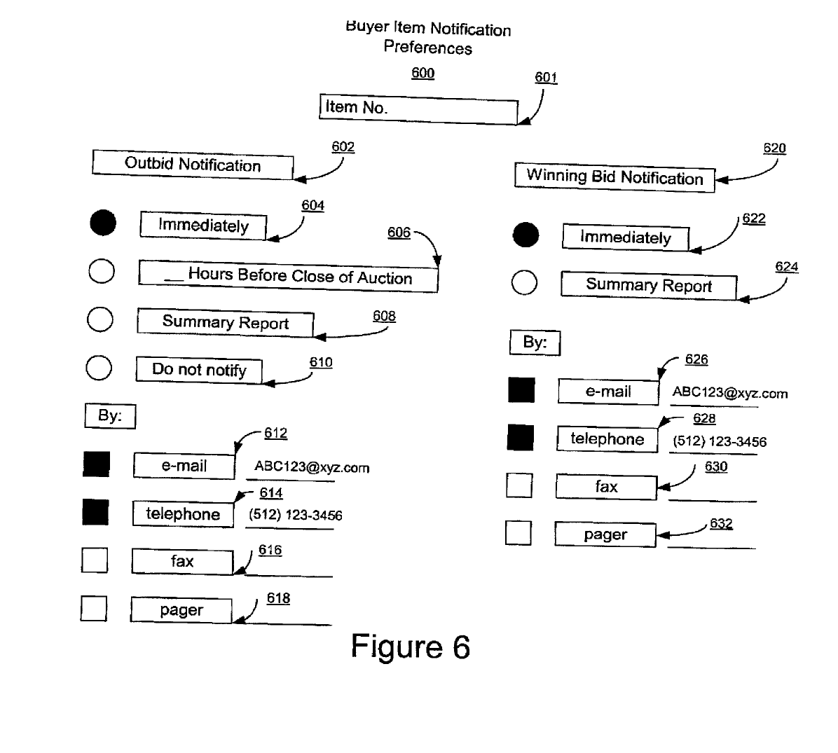

FIG. 6 is an exemplary illustration of electronic auction buyer item notification preferences screen in accordance with a preferred embodiment of the present invention. The present invention allows the buyer in an electronic auction to stay informed on the status of specific bid items for which the buyer has placed a bid including alerting the buyer when a bid period has closed. This notification may include items in which the buyer has successfully bid on as well as items the buyer has been outbid on. Notification preferences of the status of each buyer specified current bid item may be varied.

In this example, buyer item notification preferences screen 600 includes item number designation block 601. In addition, buyer item notification screen 600 contains outbid notification 602 and winning bid notification 620. A subscriber/buyer may designate when to be alerted if either of these two situations occur during the course of bidding on a specific subscriber/buyer designated item. In addition, the subscriber/buyer may choose the method to be alerted. If a subscriber/buyer does not want to designate a specific item to keep close track of during the course of the bidding period, the default summary report will be issued. However, if there is a specific item that the subscriber/buyer holds a high interest in and wants to be alerted whenever the status of the subscriber/buyer's bid changes, buyer item notification preferences screen 600 is provided by the present invention.

For example, the subscriber/buyer may designate outbid notification 602 on the specific item designated in item number block 601 which contains the choice of the subscriber/buyer being notified immediately 604, before a subscriber/buyer defined number of hours before the close of the auction 606, to be alerted in the summary report 608 or do not notify 610. The subscriber/buyer may choose to be alerted of an outbid on this item by e-mail 612, telephone 614, fax 616, or pager 618. Furthermore, e-mail 612, telephone 614, fax 616, and pager 618 has a corresponding field which the subscriber/buyer may place the appropriate address in the case of e-mail 612 or dialing digits in the case of telephone 614, fax 616 and pager 618. The subscriber/buyer may choose one or more of these notification methods. In this example, the subscriber/buyer has chosen outbid notification 602 on this item to be delivered immediately 604 by e-mail 612 with the subscriber/buyer's e-mail address, ABC123@xyz.com, placed in e-mail's 612 corresponding field and by telephone 614 with the subscriber/buyer's telephone number, (512) 123-3456, placed in telephone's 614 corresponding field.

The subscriber/buyer may also designate winning bid notification 620 on the specific item designated in item number block 601 which may be immediately 622 or in the periodic summary report 624. Winning bid notification 620 on this item may be made by e-mail 626, telephone 628, fax 630 and/or pager 632 with the appropriate address placed in the corresponding field in the case of e-mail 626 and dialing digits placed in the corresponding fields for telephone 628, fax 630 and pager 632. As in outbid notification 620, the subscriber/buyer may choose one or more of these notification methods. In this example, the subscriber/buyer has chosen winning bid notification 620 on this item to be delivered to the subscriber/buyer by e-mail 626 with the subscriber/buyer's e-mail address, ABC123@xyz.com, placed in e-mail's 626 corresponding field and by telephone 628 with the subscriber/buyer's telephone number, (512) 123-3456, placed in telephone's 628 corresponding field.

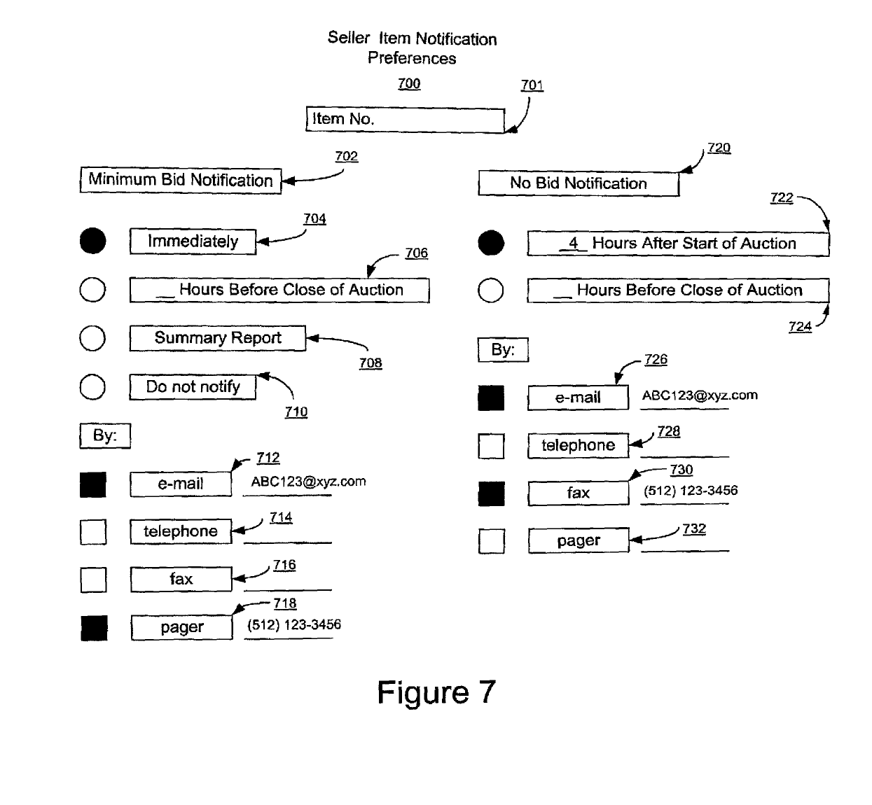

FIG. 7 is an exemplary illustration of electronic auction seller item notification preferences screen in accordance with a preferred embodiment of the present invention. The present invention allows the seller in an electronic auction to stay informed on the status of specific bid items for which the seller has placed in the auction including alerting a seller when a bid period has closed. A seller may indicate to be notified separately or immediately after the closing of the bid period on specific items, such as, for example, items which the seller has a high interest in. Notification preferences of the status of each seller specified current bid item may be varied.

In this example, seller item notification preferences screen 700 includes item number designation block 701. In addition, buyer item notification screen 700 contains minimum bid notification 702 and no bid notification 720. A subscriber/seller may designate when to be alerted if any of these two situations occur during the course of bidding on a specific subscriber/seller designated item. In addition, the subscriber/seller may choose the method to be alerted. If a subscriber/seller does not want to designate a specific item to keep close track of during the course of the bidding period, the default summary report will be issued. However, if there is a specific item that the subscriber/seller holds a high interest in and wants to be alerted whenever the bid status of the subscriber/seller's offered item changes, seller item notification preferences screen 700 is provided by the present invention.

For example, the subscriber/seller may designate minimum notification 702 on the specific item designated in item number block 701 which contains the choice of the subscriber/seller being notified immediately 704, before a subscriber/seller defined number of hours before the close of the auction 706, to be alerted in the summary report 708 or do not notify 710. The subscriber/seller may choose to be alerted of a bid which is at or above the minimum bid on this item by e-mail 712, telephone 714, fax 716, or pager 718. Furthermore, e-mail 712, telephone 714, fax 716, and pager 718 has a corresponding field which the subscriber/seller may place the appropriate address in the case of e-mail 712 or dialing digits in the case of telephone 714, fax 716 and pager 718. The subscriber/seller may choose one or more of these notification methods. In this example, the subscriber/seller has chosen minimum bid notification 702 on this item to be delivered immediately 704 by e-mail 712 with the subscriber/seller's e-mail address, ABC123@xyz.com, placed in e-mail's 712 corresponding field and by fax 718 with the subscriber/seller's fax number, (512) 123-3456, placed in fax's 718 corresponding field.

The subscriber/seller may also designate no bid notification 720 on the specific item designated in item number block 701 which may be after a subscriber/seller specified number of hours after start of the auction 722 or a subscriber/seller specified number of hours before close of the auction 724. No bid notification 720 on this item may be made by e-mail 726, telephone 728, fax 730 and/or pager 732 with the appropriate address placed in the corresponding field in the case of e-mail 726 and dialing digits placed in the corresponding fields for telephone 728, fax 730 and pager 732. As in minimum notification 720, the subscriber/seller may choose one or more of these notification methods. In this example, the subscriber/seller has chosen winning bid notification 720 on this item to be delivered to the subscriber/seller by e-mail 726 with the subscriber/seller's e-mail address, ABC123@xyz.com, placed in e-mail's 726 corresponding field and by fax 730 with the subscriber/seller's fax number, (512) 123-3456, placed in telephone's 730 corresponding field.

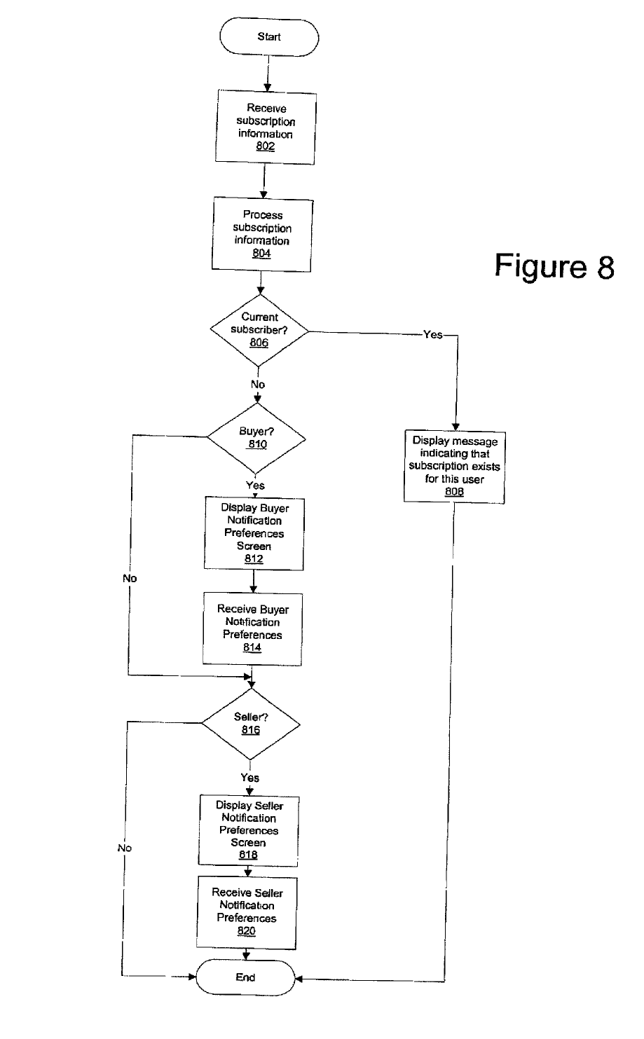

FIG. 8 is an exemplary flowchart illustrating the general process of establishing electronic auction notification preferences for a buyer and seller in accordance with a preferred embodiment of the present invention. In this example, the operation begins by receiving subscription information (step 802) for the user and processing the subscription information (step 804). Then a determination is made as to whether or not the user is a current subscriber (step 806). If the user is a current subscriber (step 806:YES) then a message is displayed indicating that a subscription exists for this user (step 808) and thereafter the operation terminates.

Otherwise, if the user is not a current subscriber (step 806:NO), then a determination is made as to whether or not the subscriber will be a buyer in electronic auctions (step 810). If the subscriber is going to be a buyer in electronic auctions (step 810:YES), then the buyer notification preferences screen is displayed (step 812). The buyer notification preferences are received (step 814). If the subscriber is not going to be a buyer in electronic auctions (step 810:NO) then the operation continues at step 816.

Whether the subscriber is not a buyer (step 810:NO) or the buyer notification preferences have been received (step 814), then a determination is made as to whether or not the subscriber is going to be a seller in electronic auctions (step 816). If the subscriber is not going to be a seller in electronic auctions (step 816:NO), the operation terminates. Otherwise, if the subscriber is going to be a seller (step 816:YES), then the seller notification preferences screen is displayed (step 818). The seller notification preferences are received (step 820) and thereafter the operation terminates.

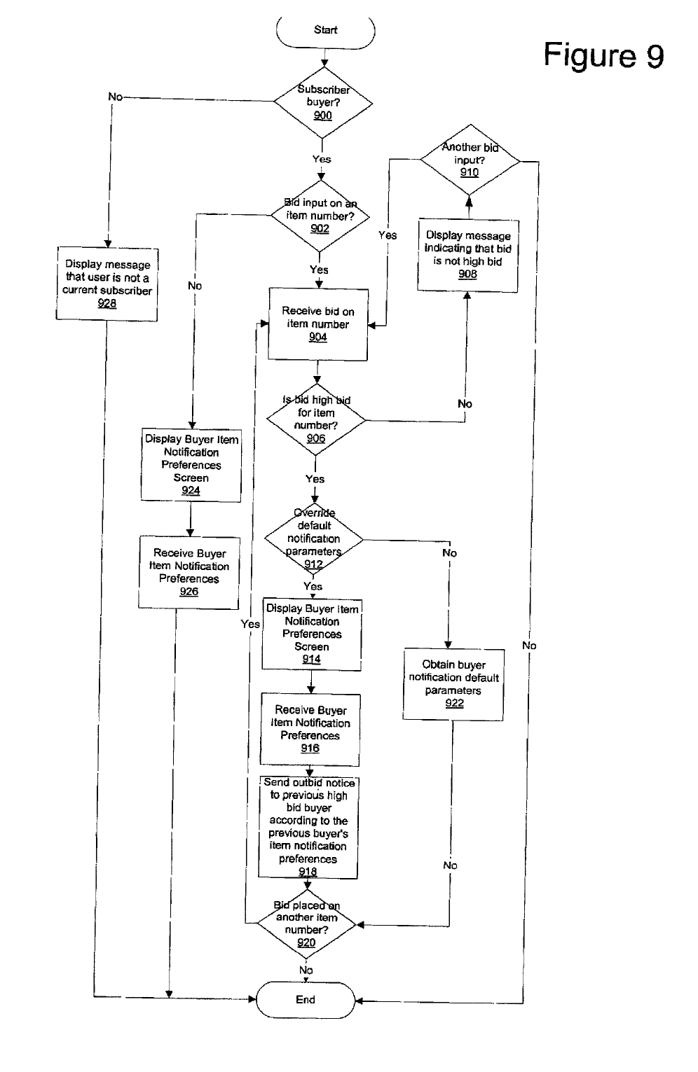

FIG. 9 is an exemplary flowchart illustrating the process of establishing electronic auction buyer item notification preferences in accordance with a preferred embodiment of the present invention. In this example, the operation begins by a determination as to whether or not the subscriber is a buyer in electronic auctions (step 900). If the subscriber is not a buyer in electronic auctions (step 900:NO) then a message is displayed indicating that the user is not a current subscriber/buyer (step 928). Otherwise, if the subscriber is a buyer in an electronic auction (step 900:YES), then a determination is made as to whether or not the buyer has placed a bid on an auction item (step 902). If the buyer has not placed a bid on an auction item (step 902:NO), then the buyer item notification preferences screen is displayed (step 924). A subscriber may not bid on an item but may designate an auction item for which to keep track of for a future bid or for general curiosity. The buyer item notification preferences are received (step 926) and thereafter the operation terminates.

Returning to step 902, if a bid was placed on an item number (step 902:YES), then the bid is received on the item number (step 904). Then a determination is made as to whether or not the bid is the high bid for the item number (step 906). If the bid is not the high bid for the item number (step 906:NO), then a message is displayed indicating that the bid is not the high bid (step 908). Then a determination is made as to whether or not another bid is placed on the item number (step 910). If another bid is not placed on the item number (step 910:NO) then the operation terminates. If another bid is placed on the item number (step 910:YES), then the operation returns to step 904 in which the bid is received on the item number.

Returning to step 906, if the bid was the high bid for the item number (step 906:YES), then a determination is made as to whether or not to override the buyer default notification parameters (step 912). If the buyer default notification parameters are not to be overridden (step 912:NO), buyer default notification parameters are obtained (step 922) and the operation continues to determine as to whether or not a bid is placed on another item number (step 920). If the default notification parameters are to be overridden (step 912:YES), then the buyer item notification preferences screen is displayed (step 914). The buyer item notification preferences are then received (step 916). Then, an outbid notice is sent to the previous high bid buyer according to that buyer's item notification preferences (step 918). Then, whether an outbid notice is sent to the previous high bid buyer (step 918) or buyer default notification parameters are obtained (step 922), a determination is made as to whether or not a bid is placed on another item number (step 920). If a bid is not placed on another item number (step 920:NO), then the operation terminates. If a bid is placed on another item number (step 920:YES), then the operation returns to step 904 in which the bid on the item number is received.

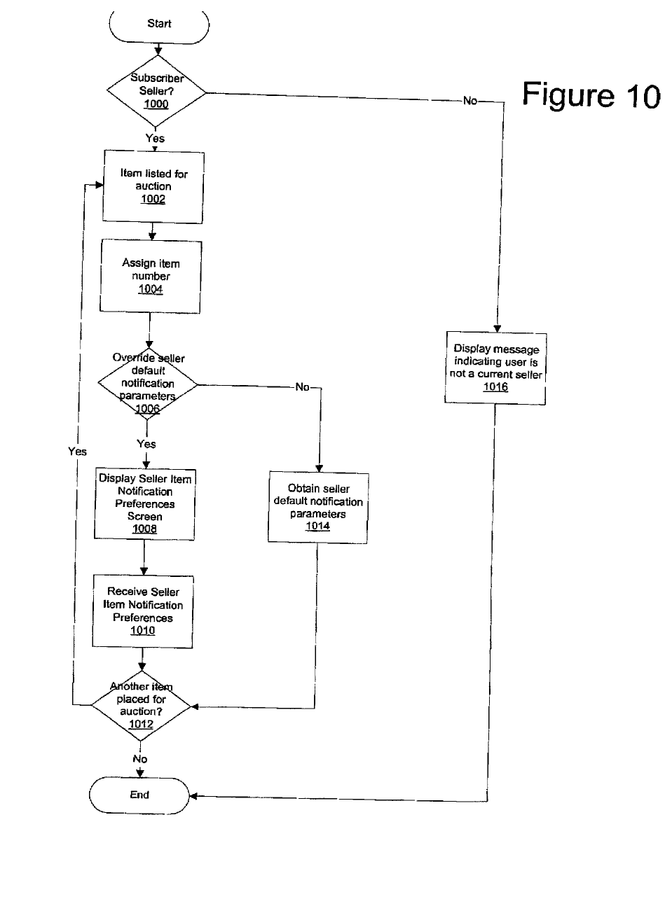

FIG. 10 is an exemplary flowchart illustrating the process of establishing electronic auction seller item notification preferences in accordance with a preferred embodiment of the present invention. In this example, the operation begins by determining as to whether or not the subscriber is a seller in electronic auctions (step 1000). If the subscriber is not a seller in electronic auctions (step 1000:NO) then a message is displayed indicating that the user is not a current subscriber/seller (step 1016) and thereafter the operation terminates. If the subscriber is a current seller in electronic auctions (step 1000:YES), then the item is listed for auction (step 1002). An item number is assigned to the item (step 1004) and then a determination is made as to whether or not to override the seller default notification parameters (step 1006). If the seller default notification parameters are not to be overridden (step 1006:NO), then the seller default notification parameters are obtained (step 1014) and the operation continues to step 1012 in which a determination is made as to whether or not another item is to be placed for auction.

If the seller default notification parameters are to be overridden (step 1006:YES, then the seller item notification preferences screen is displayed (step 1008). The seller notification item preferences are received (step 1010). Whether the seller notification item preferences are received (step 1010) or the seller default notification parameters are obtained (step 1014), a determination is then made as to whether or not another item is placed for auction (step 1012). If another item is not placed for auction (step 1012:NO), the operation terminates. Otherwise, if another item is placed for auction (step 1012:YES), then the operation returns to step 1002 in which the item is listed for auction.

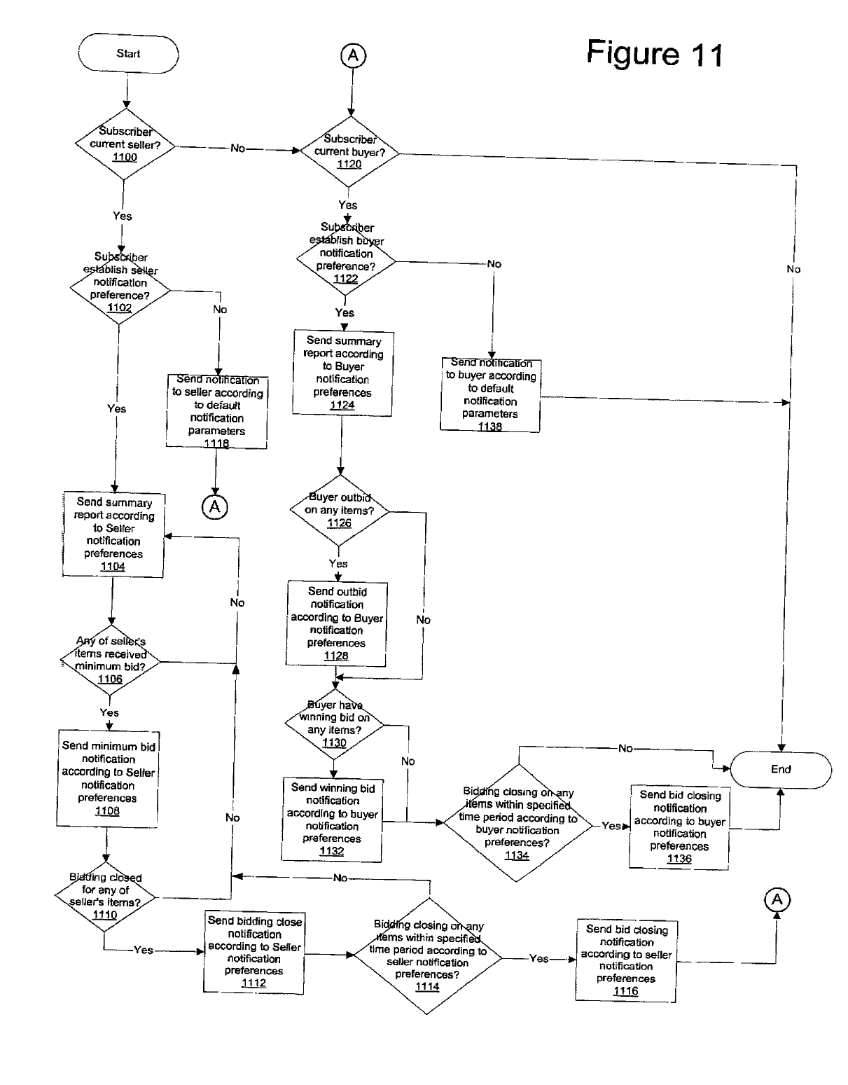

FIG. 11 is an exemplary flowchart illustrating the process of notifying an electronic auction participant in accordance with a preferred embodiment of the present invention. In this example, the operation begins by a determination as to whether or not the subscriber is a current seller (step 1100). If the subscriber is a current seller (step 1100:YES) then a determination is made as to whether or not the subscriber established seller notification preferences (step 1102). If the subscriber did not establish seller notification preferences (step 1102:NO), then notification is sent to the seller according to notification default parameters (step 1118) and thereafter the operation continues to step 1120 to determine as to whether or not the subscriber is a current buyer. If the subscriber has established seller notification preferences (step 1102:YES), then the summary report is sent to the seller according to the seller notification preferences (step 1104). Then a determination is made as to whether or not any of seller's items have received the seller's required minimum bid (step 1106). If none of seller's items have received the seller's required minimum bid (step 1106:NO), then the summary report is sent to the seller according to the seller notification preferences (step 1104).

If any of seller's items have received the seller's required minimum bid (step 1106:YES), then the minimum bid notification is sent to the seller according to the seller notification preferences (step 1108). Then a determination is made as to whether or not the bidding period has closed on any of seller's items (step 1110). If the bidding period has not closed on any of seller's items (step 1110:NO), then the summary report is sent to the seller according to the seller notification preferences (step 1104). If the bidding period has closed on any of seller's items (step 1110:YES), then a bidding closed notification is sent to the seller according to the seller notification preferences (step 1112). Then a determination is made as to whether or not the bidding period is closing on any of seller's items within the specified time period according to the seller notification preferences (step 1114). If the bidding period is not closing on any of seller's items within the specified time period according to the seller notification preferences (step 1114:NO), then the summary report is sent to the seller according to the seller notification preferences (step 1104). If the bidding period is closing on any of seller's items within the specified period according to the seller's notification preferences (step 1114:YES), then a bid closing notification is sent to the seller according to the seller notification preferences (step 1116) and then a determination is made as to whether or not the subscriber is a current buyer (step 1120).

Returning to step 1100, where a determination is made as to whether or not the subscriber is a seller, if the subscriber is not a current seller (step 1100:NO), then a determination is made as to whether or not the subscriber is a current buyer (step 1120). If the buyer is not a current buyer (step 1120:NO), then the operation terminates. Otherwise, if the subscriber is a current buyer (step 1120:YES), then a determination is made as to whether or not the subscriber has established buyer notification preferences (step 1122). If the subscriber has not established buyer notification preferences (step 1122:NO), then notification is sent to the buyer according to the default parameters (step 1138) and thereafter the operation terminates. If the subscriber has established buyer notification preferences (step 1122:YES), then the summary report is sent to the buyer according to the buyer notification preferences (step 1124). Then a determination is made as to whether or not the buyer has been outbid on any items listed in the electronic auction (step 1126). If the buyer has not been outbid on any items listed in the electronic auction (step 1126:NO), then the operation proceeds to determine whether or not the buyer has a winning bid on any items (step 1130). If the buyer has been outbid on any items listed in the electronic auction (step 1126:YES), then an outbid notification is sent to the buyer according to the buyer notification parameters (step 1128).

Then a determination is made as to whether or not the buyer has won a bid on any items listed in the electronic auction (step 1130). If the buyer has not won a bid on any item listed in the electronic auction (step 1130:NO), then a determination is made as to whether or not bidding has closed on any items within the specified time period according to the buyer notification preferences (step 1134). If the buyer has won a bid on any item listed in the electronic auction (step 1130:YES), then a winning bid notification is sent to the buyer according to the buyer notification preferences (step 1132). Then a determination is made as to whether or not the buyer has bid on any items closing within the specified time period according to the buyer notification preferences (step 1134). If the buyer has not bid on any items closing within the specified time period according to the buyer notification preferences (step 1134:NO), then the operation terminates. If the buyer has bid on any items closing within the specified time period according to the buyer notification preferences (step 1134:YES), then a notification is sent to the buyer indicating that bidding is closing according to the buyer notification preferences (step 1136) and thereafter the operation terminates.

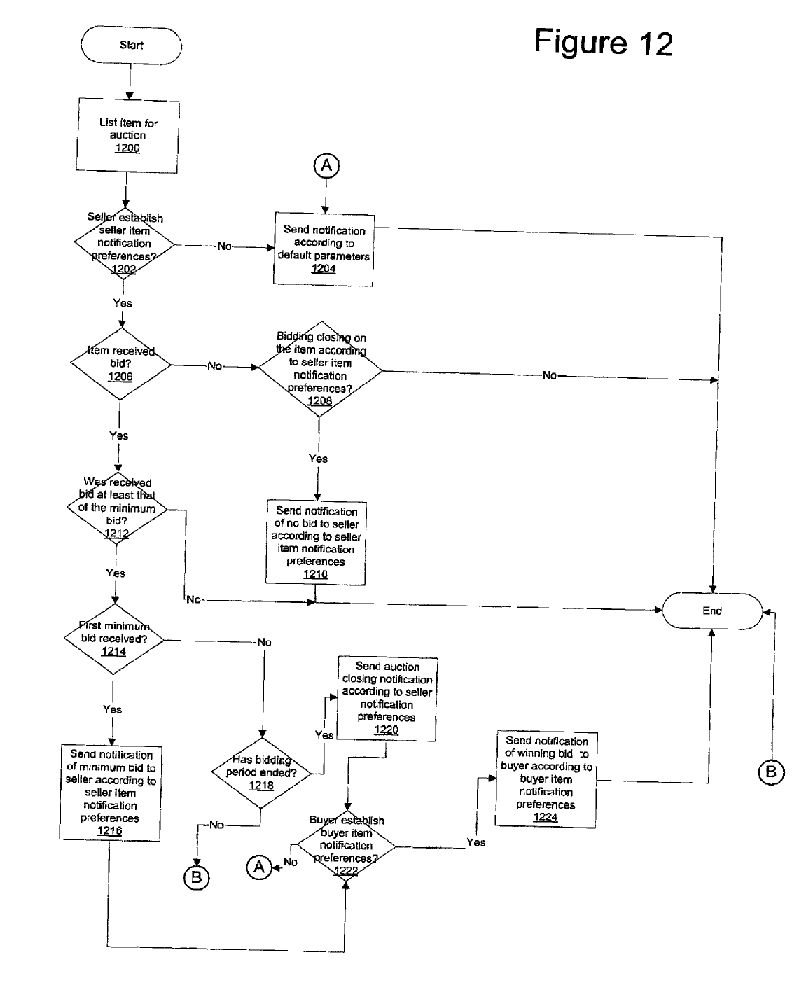

FIG. 12 is an exemplary flowchart illustrating the process of notifying an electronic auction participant of the status of an auctioned item in accordance with a preferred embodiment of the present invention. In this example, the operation begins by listing an item for auction (step 1200). Then a determination is made as to whether or not the seller has established subscriber/seller item notification preferences (step 1202). If the subscriber/seller has not established item notification preferences (step 1202:NO), then notification is sent to subscriber/seller according to default parameters (step 1204) and thereafter the operation terminates. If the subscriber/seller has established item notification preferences (step 1202:YES), then a determination is made as to whether or not if the item the subscriber/seller placed in auction has received a bid (step 1206). If the item the subscriber/seller placed in the auction has not received a bid (step 1206:NO), then a determination is made as to whether or not the bidding period is closing on the item within the time period specified by the subscriber/seller in the seller item notification preferences (step 1208). If the bidding period is not closing on the item within the time period specified by the subscriber/seller in the seller item notification preferences (step 1208:NO), the operation terminates. If the bidding period is closing on the item within the time period specified by the subscriber/seller in the seller item notification preferences (step 1208:YES), then a notification is sent to the subscriber/seller according to seller item notification preferences indicating that the item has not received a bid (step 1210) and thereafter the operation terminates.

Returning to step 1206, if the item has received a bid (step 1206:YES), then a determination is made as to whether or not the bid was at least that of the seller's required minimum bid on the item (step 1212). If the received bid was not at least that of the seller's required minimum bid on the item (step 1212:NO), the operation terminates. If the received bid was at least that of the seller's required minimum bid on the item (step 1212:YES), then a determination is made as to whether or not the first minimum bid was received (step 1214). If the first minimum bid was received (step 1214:YES), then a notification is sent to the seller according to the seller item notification preferences (step 1216) and then a determination is made as to whether or not the buyer has established buyer item notification preferences (step 1220). If the first minimum bid was not received (step 1214:NO), then a determination is made as to whether or not the bidding period has ended for the item (step 1218). If the bidding period has not ended (step 1218:NO), then the operation terminates. If the bidding period has ended (step 1218:YES), an auction closing notification is sent to the seller according to seller notification preferences (step 1220). Then a determination is made as to whether or not the buyer has established buyer item notification preferences (step 1222).

Whether a notification of the minimum bid was sent to seller according to the seller item notification preferences (step 1216) or an auction notification was sent to the seller according to seller notification preferences (step 1220), a determination is made as to whether or not the buyer has established buyer item notification preferences (step 1222). If the buyer has not established buyer item notification preferences (step 1222:NO), then a notification is sent to the buyer according to the default parameters (step 1204) and thereafter the operation terminates. If the buyer has established buyer item notification preferences (step 1220:YES), then a notification is sent to the buyer according to the buyer item notification preferences (step 1224) and thereafter the operation terminates.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as a floppy disc, a hard disk drive, a RAM, and CD-ROMs and transmission-type media such as digital and analog communications links.

Therefore, the present invention provides a method of notifying a subscriber involved in an electronic auction. The subscriber may be an interested party which may also include a buyer and a seller in the auction. The subscriber may choose and define preferences in which to be notified upon the occurrence of specific events during or after an item's auction period. The subscriber may specify when to be contacted upon the occurrence of an event and the methods in which to be contacted.

The description of the present invention has been presented for purposes of illustration and description, but is not intended to be exhaustive or limited to the invention in the form disclosed. Many modifications and variations will be apparent to those of ordinary skill in the art. For example, the process of establishing notification preferences for both the buyer and seller were illustrated as being performed when subscribing to an electronic auction website, but the notification preferences may be also specified by a buyer and a seller at anytime the buyer and seller have a current subscription to the electronic auction website. In addition, the process of establishing item notification preferences for both the buyer and seller were illustrated as being performed when a seller first listed the item for auction and when a buyer first bid on the item, but the item notification preferences may also be specified by a buyer and seller at anytime before the item's bidding period ends. In addition, subscriber notification preferences and subscriber item notification preferences may be changed at any time.

Furthermore, both default notification parameters and subscriber notification preferences may be employed to notify a participant in an electronic auction of the status of a bid or an auction item during the bidding period and for a specified period of time thereafter. Also, subscriber default notification parameters are not necessarily required fields. There may be several layers of notifications, such as, for example, a system default notification procedure, a buyer and/or seller default notification feature specified from the buyer and seller notification preferences and a buyer and/or seller item specific notification which may be specified regardless of whether the buyer and/or seller has entered a general default notification preference. The embodiment was chosen and described in order to best explain the principles of the invention, the practical application, and to enable others of ordinary skill in the art to understand the invention for various embodiments with various modifications as are suited to the particular use contemplated.

1. A method of notifying a client of a status of an electronic auction, comprising the steps of:
receiving a notification preference, the notification preference identifying when to notify the client of a status of the electronic auction;
matching the notification preference to a current status of the electronic auction; and
transmitting a notification to the client based on the matching of the notification preference to the current status of the electronic auction.

2. The method of claim 1, further comprising:
displaying a selectable presentation of at least one notification criteria, the notification criteria identifying a plurality of auction sequences and a method in which to deliver the notification.

3. The method of claim 2, further comprising:
displaying a selectable presentation of at least one notification transmission method.

4. The method of claim 3, wherein the notification transmission method is at least one of electronic mail, a telephone, a facsimile and a pager.

5. The method of claim 1, wherein the notification preference is at least one of a minimum bid notification, a no bid notification, a bidding close notification, an outbid notification and a winning bid notification.

6. The method of claim 1, further comprising:
receiving a notification preference, the notification preference identifying at least one auction item;
matching the notification preference to a current status of the auction of the at least one item; and
transmitting a notification to a subscriber based on the matching of the notification preference to a current status of the auction of the item.

7. The method of claim 1, wherein the notification preference comprises default notification parameters.

8. The method of claim 1, wherein the subscriber is an interested party.

9. The method of claim 1, wherein the subscriber is at least one of a buyer and a seller in the auction.

10. A system having means for notifying a client of a status of an electronic auction, comprising:
receiving means for receiving a notification preference, the notification preference identifying when to notify the client of a status of the electronic auction;
matching means for matching the notification preference to a current status of the electronic auction; and
transmitting means for transmitting a notification to the client based on the matching of the notification preference to the current status of the electronic auction.

11. The system of claim 10, further comprising:
displaying means for displaying a selectable presentation of at least one notification criteria, the notification criteria identifying a plurality of auction sequences and a method in which to deliver the notification.

12. The system of claim 11, further comprising:
displaying means for displaying a selectable presentation of at least one notification transmission method.

13. The system of claim 12, wherein the notification transmission method is at least one of electronic mail, a telephone, a facsimile and a pager.

14. The system of claim 10, wherein the notification preference is at least one of a minimum bid notification, a no bid notification, a bidding close notification, an outbid notification and a winning bid notification.

15. The system of claim 10, further comprising:
receiving means for receiving a notification preference, the notification preference identifying at least one auction item;
matching means for matching the notification preference to a current status of the auction of the at least one item; and
transmitting means for transmitting a notification to a subscriber based on the matching of the notification preference to a current status of the auction of the item.

16. The system of claim 10, wherein the notification preference comprises default notification parameters.

17. The system of claim 10, wherein the subscriber is an interested party.

18. The system of claim 10, wherein the subscriber is at least one of a buyer and a seller in the auction.

19. A computer program on a computer usable medium having computer readable program code for notifying a client of a status of an electronic auction, comprising:
first instructions receiving a notification preference, the notification preference identifying when to notify the client of a status of the electronic auction;
second instructions for matching the notification preference to a current status of the electronic auction; and
third instructions for transmitting a notification to the client based on the matching of the notification preference to the current status of the electronic auction.

20. The computer program of claim 19, further comprising:
fourth instructions for displaying a selectable presentation of at least one notification criteria, the notification criteria identifying a plurality of auction sequences and a method in which to deliver the notification.

21. The computer program of claim 20, further comprising:
fifth instructions for displaying a selectable presentation of at least one notification transmission method.

22. The computer program of claim 21, wherein the notification fifth instruction further include instructions for the transmission method to be at least one of electronic mail, a telephone, a facsimile and a pager.

23. The computer program of claim 19, wherein the first instructions further include instructions for the notification preference to be at least one of a minimum bid notification, a no bid notification, a bidding close notification, an outbid notification and a winning bid notification.

24. The computer program of claim 19, further comprising:
sixth instructions for receiving a notification preference, the notification preference identifying at least one auction item;
seventh instructions for matching the notification preference to a current status of the auction of the at least one item; and
eighth instructions for transmitting a notification a subscriber based on the matching of the notification preference to a current status of the auction of the item.

25. The computer program of claim 19, wherein the first instructions further include instructions for the notification preference to comprise default notification parameters.

26. The computer program of claim 19, wherein the subscriber is an interested party.

27. The computer program of claim 19, wherein the subscriber is at least one of a buyer and a seller.
